(19) United States
(12) Patent Application Publication
(10) Pub. No.: US 2012/0077017 A1
(43) Pub. Date: Mar. 29, 2012

(54) PROCESS FOR PRODUCING A METAL MATRIX COMPOSITE MATERIAL

(76) Inventors: Isabell Buresch, Illertissen (DE); Werner Kroemmer, Landshut (DE)

(21) Appl. No.: 13/375,685

(22) PCT Filed: May 27, 2010
(86) PCT No.: PCT/EP10/03242

§ 371 Date: Dec. 1, 2011

(30) Foreign Application Priority Data
Jun. 3, 2009 (DE) 10 2009 026 655.0

(51) Int. Cl. B32B 15/00; B32B 5/16; C23C 4/04; C23C 4/18; B32B 5/18; H01B 1/04; B82Y 99/00; B82Y 30/00

(52) U.S. Cl. 428/312.8; 252/503; 427/450; 427/448; 977/779; 977/742

(57) ABSTRACT

The invention proposes a process for producing a metal matrix composite material composed of a metal matrix having at least one metal component and at least one reinforcing component arranged in the metal matrix, in which at least one of the components is sprayed onto a substrate by means of a thermal spraying process, use being made of at least one reinforcing component comprising carbon in the form of nano tubes, nano fibers, graphenes, fullerenes, flakes or diamond. Also proposed is a corresponding material, in particular in the form of a coating, and the use of such a material.

The invention relates to a process for producing a metal matrix composite material comprising a metal matrix, which has at least one metal component, and at least one reinforcing component arranged in the metal matrix, to a corresponding material, in particular in the form of a coating, and also to the use of such a material.

The trend toward increasing miniaturization, the pressure in terms of costs which accompanies increasing material costs and also the ever more demanding requirements for electrical and electronic applications and for the production of technical bearings call for new materials and coatings.

Compared with exclusively ceramic or metallic materials, metal matrix composite materials or metal matrix composites (MMCs) have outstanding combinations of properties. For this reason, there is great interest in using the MMCs, which were originally developed for air and space travel and for military technology, for a series of applications.

The name MMC frequently refers exclusively to correspondingly reinforced aluminum, but in special cases it also denotes reinforced magnesium and copper materials. The metal component of the MMCs is present in the form of elemental metal or in the form of an alloy. As the reinforcing phase or component, use is generally made of particles (reinforcing particles) (diameter 0.01-150 μm), short fibers (diameter 1-6 μm, length 50-200 μm), continuous fibers (diameter 5-150 μm) or foams with an open porosity, which generally consist of ceramic material (SiC, Al₂O₃, B₄C, SiO₂) or carbon in the form of fibers or graphite (see in this respect and also hereinbelow: “Metallmatrix-Verbundwerkstoffe: Eigenschaften, Anwendungen and Bearbeitung” [Metal matrix composite materials: properties, applications and machining] by Dr. O. Beffort, 6th International IWF Colloquium, Apr. 18/19, 2002, Egerkingen, Switzerland).

Essentially three procedures are known from the prior art for producing MMC bulk materials, specifically stirring ceramic particles into the metal melt, melt infiltration and powder metallurgy. Electrodeposition is known from the prior art for producing MMC coatings.

In corresponding stirring-in processes, it is frequently necessary to overcome the lack of wettability between the metal melt and the particles and to limit a reaction between the two phases. For reasons of viscosity, the content of the particles is limited to a maximum of 30% by volume.

In infiltration, the reinforcing component is processed to form a porous preform, into which the metal melt is then infiltrated with or without the use of pressure. In this case, it is also possible to use fibers and foams, besides particles, with very high reinforcement volume contents (up to about 80%) as the reinforcement. Local reinforcement in regions of extremely high loading is possible. Corresponding processes are complex, however.

The powder metallurgy (PM) of MMCs differs from conventionally used PM processes merely in that a powder mixture of ceramic particles or reinforcing component particles and metal particles is used instead of a metal powder. In principle, the PM is suitable only for fine particles (grain size 0.5-20 μm). In addition, it must be ensured that the MMCs obtained can be subsequently deformed by extrusion, forging or rolling, and therefore the maximum content of the reinforcing particles is restricted to about 40% by volume.

The electrodeposition of dispersion layers is associated with the problem of keeping the particles floating in a fine distribution in the electrolyte and of depositing the particles at the same time as the matrix, in order to obtain homogeneous layers. The simultaneous deposition of the particles and the matrix is impossible in many cases on account of their different potentials.

Carbon nanotubes (CNTs) have outstanding properties. These include, for example, their mechanical tensile strength of about 40 GPa and their stiffness of 1 TPa (20 and 5 times that of steel, respectively). There are both CNTs with conducting properties and also those with semiconducting properties. CNTs belong to the family of the fullerenes and have a diameter of 1 nm to several 100 nm. Their walls, like those of the fullerenes or like the planes of graphite, consist only of carbon. A mixture of CNTs with further components, in particular, gives reason to expect composite materials and coatings with significantly improved properties.

It is known to mix CNTs with conventional plastic in order to improve the mechanical and electrical properties thereof. CNT composite materials based on metal, as discussed for example in DE 10 2007 001 412 A1, comprise a metal matrix, such as Fe, Al, Ni, Cu or corresponding alloys, and carbon nanotubes as the reinforcing component in the matrix. On account of the large differences in density between metals and CNTs, and the strong tendencies toward segregation brought about as a result, and also on account of the lack of wettability of the CNTs with metal, a melt-metallurgy application for producing corresponding metal-CNT composite materials is problematic. DE 10 2007 001 412 A1 therefore proposes the deposition of a composite coating applied by electroplating on a substrate by using a plating solution which contains metal cations of a metallic matrix to be deposited and also carbon nanotubes. The composite coating then comprises the metallic matrix and carbon nanotubes arranged in the matrix, as a result of which the mechanical and tribological properties of the coating are improved. In many sectors, however, application by electroplating is not possible or is possible only with difficulty.

The invention is based on the object of specifying a process for producing a metal matrix composite material, in particular with CNTs as the reinforcing component, which makes it possible to distribute the components used as uniformly as possible in a technically simple manner, where in particular the physico-chemical properties of the reinforcing components should as far as possible be unchanged and the reinforcing components should be present in the metal matrix composite material in the highest possible percentage.

This object is achieved by a process for producing a metal matrix composite material and by such a metal matrix composite material, which can be used as such as a workpiece or as a coating of a workpiece or as a material for producing a workpiece, having the features of the independent patent claims. Preferred configurations are given in the respective dependent claims.

For producing a metal matrix composite material for electrical structural elements, electrical components or heat sinks, comprising a metal matrix, which has at least one metal component, and at least one reinforcing component arranged in the metal matrix, the invention contains the technical teaching of spraying at least one of the components onto a substrate by a thermal spraying process, wherein the at least one reinforcing component used is carbon in the form of nanotubes, nanofibers, graphenes, fullerenes, flakes or diamond.

Composite particles such as single-walled and multi-walled CNTs (SW-/MW-CNTs) having a length of 0.2 to 1000 μm, preferably of 0.5 to 500 μm, and a bundle size of 5 to 1200 nm, preferably of 40 to 900 nm, have proved to be particularly advantageous in this respect. In order for their properties to be improved, it is also possible for SW-CNT or MW-CNT cold-spray particles to be encapsulated or coated beforehand with metals such as Cu or Ni via chemical processes. A further, advantageous variant consists in mixing the metal powder with a CNT dispersion/suspension and then drying the mixture, such that the metal powder particles are encapsulated with the CNTs. The proportion of SW-CNTs or MW-CNTs in the carrier gas or in the powder stream ranges from 0.1 to 30%, for example, preferably from 0.2 to 10%.

With the aid of one of the spraying processes mentioned, it is possible to incorporate single-walled and multi-walled CNTs in a metal matrix. According to investigations carried out by the applicant, an MMC coating or a corresponding MMC strip produced in this way, having at least 0.3% of SW-CNTs or MW-CNTs, shows an extraordinary wear behavior, with coefficients of friction and contact resistance values which lie well below the values known to date for comparable metal layers. Carbon in the form of nanotubes, fullerenes, graphenes, flakes, nanofibers, diamond or diamond-like structures can be used with particular advantage as the reinforcing component. Composite particles such as single-walled and multi-walled CNTs (SW-/MW-CNTs) having a length of 0.2 to 1000 μm, preferably of 0.5 to 500 μm, and a bundle size of 5 to 1200 nm, preferably of 40 to 900 nm, have proved to be particularly advantageous in this respect. In order for their properties to be improved, it is also possible for SW-CNT or MW-CNT cold-spray particles to be encapsulated or coated beforehand with metals such as Cu or Ni via chemical processes. A further, advantageous variant consists in mixing the metal powder with a CNT dispersion/suspension and then drying the mixture, such that the metal powder particles are encapsulated with the CNTs. The proportion of SW-CNTs or MW-CNTs in the carrier gas or in the powder stream ranges from 0.1 to 30%, for example, preferably from 0.2 to 10%.

With the aid of one of the spraying processes mentioned, it is possible to incorporate single-walled and multi-walled CNTs in a metal matrix. According to investigations carried out by the applicant, an MMC coating or a corresponding MMC strip produced in this way, having at least 0.3% of SW-CNTs or MW-CNTs, shows an extraordinary wear behavior, with coefficients of friction and contact resistance values which lie well below the values known to date for comparable metal layers.

Relevant spraying processes make it possible to use metal powders which have been mixed beforehand, for example, with carbon components such as CNTs or else ceramic reinforcing components. The proportion of metallic particles in the carrier gas can lie, for example, in a range from 0.1 to 50%.

Spraying processes, such as flame spraying, plasma spraying and cold spraying, are known from the prior art for producing coatings. In flame spraying, a pulverulent, cord-like, rod-like or wire-like coating material is heated in a combustion-gas flame and, with the supply of additional carrier gas, for example compressed air, is sprayed at a high velocity onto a base material. In plasma spraying, powder is injected into a plasma jet, said powder being melted by the high plasma temperature. The plasma stream carries the powder particles along and hurls them onto the workpiece to be coated.

In cold spraying, as described for example in EP 0 484 533 B1, the spray particles are accelerated to high velocities in a relatively cold carrier gas. The temperature of the carrier gas is a few hundred ° C. and lies below the melting temperature of the lowest-melting sprayed component. The coating is formed when the particles strike against the metal strip or structural part with a high kinetic energy, where the particles which do not melt in the cold carrier gas form a dense and firmly adhering layer upon impact. The plastic deformation and the resultant local release of heat thereby ensure very good cohesion and bonding of the sprayed layer on the workpiece. On account of the relatively low temperatures, and since it is possible to use argon or other inert gases as the carrier gas, it is possible to avoid oxidation and/or instances of phase transformation of the coating material in the case of cold spraying. The spray particles are added in the form of powder, generally having a particle size of 1 to 100 μm. The spray particles obtain the high kinetic energy when the carrier gas is expanded in a Laval nozzle.

In the present invention, it is preferred that at least one of the components is sprayed by cold spraying, flame spraying, in particular high-velocity flame spraying (HVOF), and/or plasma spraying. It is also envisaged, in particular in the case of cold spraying, to use a carrier gas which is at a temperature which is equal to room temperature or else below room temperature, as a result of which it is possible to reliably avoid thermal loading of the sprayed components, in particular of the reinforcing components. By way of example, the temperature can reach up to 10% below the melting temperature of the lowest-melting component. At the same time, the carrier gas should create an inert or even reducing atmosphere, in order to prevent oxidation of the powder particles and so as not to thereby have a negative influence, inter alia, on the later properties of the layer or material, such as the electrical conductivity. In particular, a combination of two spraying processes can also be used. It is likewise possible to use two spray nozzles with a mixture of the corresponding components at the coating site.

The measures mentioned make it possible to achieve significantly improved properties of the coatings and materials thereby produced. The corresponding products have an increased wear resistance, better sliding properties and a higher resistance to frictional corrosion, it being possible for the coefficient of friction to be reduced down to about one tenth of the value of the respective pure metal. Furthermore, the conductivity and the hardness of the materials are increased.

The invention provides a particularly flexible and cost-effective process since, by way of example for the production of conductor tracks and leadframes by the provided spraying processes, no prefabrication steps such as rolling, punching or annealing are required.

In the process according to the invention, a film or a substrate which cannot be wetted by the powder jet can serve as the substrate, and this makes it possible to separate metal matrix composite materials which have been sprayed on from the substrate. It is thereby possible to obtain a structural part or a pure material, for example in the form of a strip, which can then be further processed in a suitable manner.

However, it is also possible to adhesively coat strip materials and structural parts, such as electromechanical components, heat sinks, bearings and bushes, in a targeted manner, these having properties which are improved as a result of the metal matrix composite material. For coating within the context of the present invention, it is preferable to use a metal strip or an electromechanical structural part as the workpiece which preferably consists of ceramic, titanium, copper, aluminum and/or iron and also alloys thereof. Semi-finished products or 3D structures, such as molded interconnection devices (MIDs), can also be used for coating.

According to a particularly preferred embodiment, the process includes at least one surface machining step. In this respect, an activation layer, a bonding layer and/or a diffusion barrier layer can be applied, by way of example, to a metal strip or a structural part made of a metallic material, and the MMCs are then sprayed onto said layer. If no adhesive coating is intended, but rather, as indicated above, a pure metal matrix composite material is to be obtained, it is also possible to apply a non-stick coating instead of a bonding layer.

Corresponding MMC strips or coatings can also be retroactively subjected to additional treatment, such as leveling or a reflow/heat treatment, in order to smooth the surface. For deformation, it is also possible, for instance, to retroactively perform a soft-annealing step, for example at about 0.4 times the melting temperature of the matrix metal. To compact the material and/or to reduce the porosity at the surface, it is possible for the material to be rerolled, for example with a degree of deformation of 0.1 to 10%.

In corresponding processes, at least one metal component and/or at least one reinforcing component is advantageously provided in particle form. By appropriately selecting the structure, orientation, size and form of the particles and also the quantity thereof, it is possible to positively influence the material properties of matrix materials. It is also possible, if appropriate, to promote or prevent the formation of whisker crystals by suitable boundary conditions.

In a particularly advantageous manner, a first component can also be mixed with at least one further component before spraying. Gentle mixing, for example of cold-spray particles, can be effected by encapsulating the particles with a dispersion or suspension which contains the reinforcing particles, and subsequent drying. Depending on the hardness of the particles, mixing in a ball mill or in an attritor comprising at least two different components under protective gas can have the effect that the particle form is destroyed and therefore the flow properties of the powder are adversely affected.

In such a process, and within the context of an advantageous configuration, it is possible to use at least one organic and/or at least one ceramic reinforcing component. This can be present in the sprayed mixture or else can be sprayed in or co-sprayed.

An advantageous process comprises the use of at least one reinforcing component, which is selected from the group consisting of tungsten, tungsten carbide, tungsten carbide-cobalt, cobalt, boron, boron carbide, Invar, Kovar, niobium, molybdenum, chromium, nickel, titanium nitride, aluminum oxide, copper oxide, silver oxide, silicon nitride, silicon carbide, silicon oxide, zirconium tungstate and zirconium oxide.

In this respect, a reinforcing component can also be used together with at least one further reinforcing component and/or can be appropriately sprayed in or admixed. By using known ceramic components, it is possible to exploit the advantageous properties thereof, even in addition to those of other reinforcing components. By using boron, cobalt, tungsten, niobium, molybdenum and alloys thereof and Invar or Kovar, it is possible to positively influence the coefficient of thermal expansion of the composite material.

In an advantageous manner, it is possible to use a metal matrix composite material or a coating having a metal matrix which has at least one metal and/or an alloy of a metal which is selected from the group consisting of tin, copper, silver, gold, nickel, zinc, platinum, palladium, iron, titanium and aluminum. As a result, it is possible, for example, to provide a particularly advantageous wear resistance, corrosion resistance and/or a specific electrical or thermal conductivity and also an appropriate coefficient of expansion.

The invention likewise relates to a metal matrix composite material which is produced by the process according to the invention and comprises a metal matrix, which has at least one metal component, and at least one reinforcing component arranged in the metal matrix.

In this case, a metal matrix composite material which has a proportion of 0.1 to 20%, preferably of 0.1 to 5%, preferably of 0.2 to 5% of carbon nanotubes is considered to be particularly advantageous. As explained above, said proportions have proved to be particularly advantageous in practice.

A corresponding metal matrix composite material having advantageous properties has, by way of example, a residual porosity of 0.2 to 20% in relation to the reinforcing component and/or of 0.2 to 10% in relation to the metal component. MMCs having such residual porosities can be used advantageously when a particularly good abrasion resistance, such as for example in bearings or at sliding surfaces, or a high electrical conductivity, such as for example in conductor tracks, is required.

The metal matrix composite material according to the invention is particularly suitable for a coating for a workpiece. By way of example, the coating can be applied to bearings and sliding elements, heat sinks, plug-in connectors, leadframes and conductor tracks, in particular to conductor tracks which can be used as heating elements. Such MMC coatings can consist for instance of Sn, Cu, Ag, Au, Ni, Zn, Pt, Pd, Fe, Ti, W and/or Al and alloys thereof such as solders, in particular having a proportion of SW-CNTs or MW-CNTs of 0.1 to 20%, preferably of 0.2 to 5%.

In particular, this can involve a coated strip for use in electromechanical structural elements such as plug-in connectors, springs, e.g. for relays, switching contacts, conductor tracks in leadframes and heating elements or heat sinks and cooling elements. The metal strip preferably has a thickness of 0.01 to 5 mm, particularly preferably of 0.06 to 3.5 mm. For the production of strips consisting merely of the metal matrix composite material, it is also possible, as mentioned, to spray the components onto a non-wettable substrate, for example, such as films made of PEEK, polyimide or Teflon. Correspondingly produced leadframes, conductor tracks, heating elements and strips can comprise Cu, Al, Ni and Fe and also alloys thereof.

Conductor tracks which comprise at least one metal matrix composite material produced in the above manner can be sprayed locally onto a printed circuit board, MID (molded interconnection device) structures of, for example, LSDS or other thermoplastics, in particular via templates, or can be provided in the form of an areal coating, which is later further processed, for example by suitable photolithography processes.

An MMC strip or a conductor track can advantageously consist of Cu, Ag, Al, Ni and/or Sn and alloys thereof with a proportion of SW-CNTs or MW-CNTs of 0.1 to 20%, preferably of 0.1 to 5%.

With respect to further features and advantages, reference should be made expressly to the deliberations in relation to the production process according to the invention.

A metal matrix composite material produced in accordance with the process according to the invention is particularly suitable for use in the production of workpieces, in particular electromechanical components. Such a use can comprise either producing the workpiece entirely from the metal matrix composite material, or performing coating with such a material.

### FIGURES

The invention and the advantages thereof and also further configurations of the invention are explained in more detail hereinbelow with reference to the exemplary embodiments shown in the figures. In detail:

FIG. 1 is a schematic illustration showing an apparatus for cold spraying, which is suitable for carrying out a process according to a particularly preferred embodiment of the invention, and

FIG. 2 shows microscopic micrographs of the microstructure and scanning electron microscope images of the surfaces of metal matrix composite materials which are produced by means of processes according to particularly preferred embodiments of the present invention.

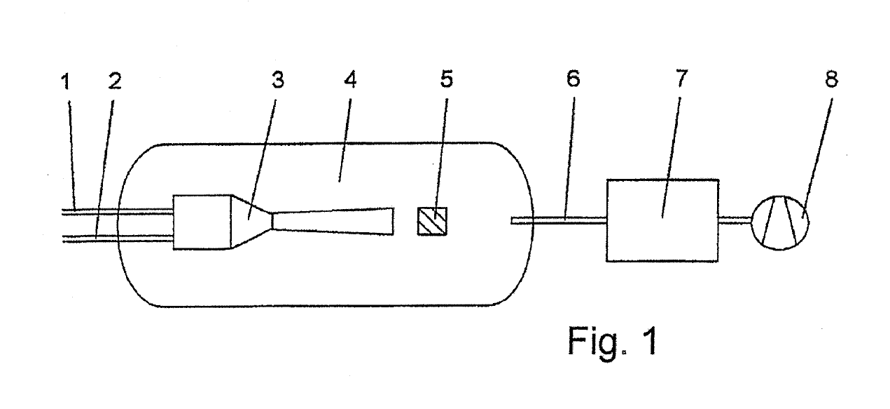

FIG. 1 shows an apparatus for cold spraying, which is suitable for carrying out the process according to a particularly preferred embodiment of the invention. The apparatus has a vacuum chamber 4, in which a substrate 5 to be coated can be positioned in front of the nozzle of a cold spray gun 3, for example. However, it should be understood that such a spraying process could also take place at atmospheric pressure, which does not require a vacuum chamber. The workpiece 5 is positioned in front of the cold spray gun 3 by means of a mount, for example, which is not shown in FIG. 1 for reasons of clarity. The substrate 5 is preferably arranged so as to be movable, i.e. displaceable and rotatable, such that coating can take place at a plurality of positions, in particular in strip form or areally. As an alternative or in addition thereto, the cold spray gun 3 can also be arranged so as to be movable.

In order to coat the substrate 5, the vacuum chamber 4 is evacuated and the cold spray gun 3 is used to produce a gas jet, into which particles for coating the workpiece 5 are fed.

In this case, the main gas stream, for example a mixture of helium and nitrogen comprising about 40% by volume of helium, passes via the gas supply line 1 into the vacuum chamber 4. The spray particles, for example a metal powder with admixed CNTs, pass in the auxiliary gas stream via the supply line 2 into the vacuum chamber 4, in which a pressure of about 40 mbar prevails, where they pass into the cold spray gun 3. To this end, the supply lines 1, 2 are guided into the vacuum chamber 4, in which both the cold spray gun 3 and the substrate 5 are located. Provision may also be made for a plurality of components to be sprayed to be supplied via a plurality of auxiliary gas streams. The entire cold spraying process therefore takes place in the vacuum chamber 4. The particles are accelerated by the cold gas jet to such an extent that the particles adhere to the surface of the workpiece 5 to be coated by conversion of the kinetic energy of the particles into thermal energy. The particles can additionally be heated up to the above-indicated maximum temperature.

The carrier gas, which, during cold spraying, leaves the spray gun 3 together with the spray particles and carries the spray particles to the workpiece 5, passes into the vacuum chamber 4 after the spraying process. The consumed carrier gas is removed from the vacuum chamber 4 via the gas line 6 by means of the vacuum pump 8. A particle filter 7, for example, is connected between the vacuum chamber 4 and the vacuum pump 8 and removes free spray particles from the consumed carrier gas in order to prevent the spray particles from damaging the pump 8.

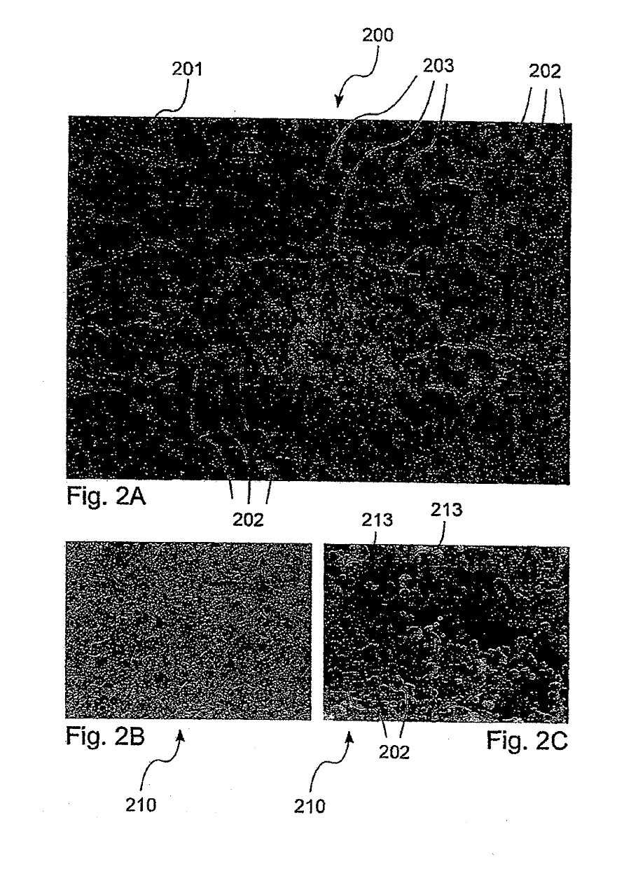

Partial FIGS. 2A to 2C of FIG. 2 show results of tests in each of which metal powders were sprayed with the addition of reinforcing components. The figures show images of microsections and scanning electron microscope images of the surface of the layers thereby obtained. Within the context of the tests, use was made of commercially available Cu powder, SnAg₃ powder and Sn powder together with suitable MW-CNTs from the manufacturer Ahwahnee (P/N ATI-BMWCNT-002).

FIG. 2A shows a microsection, with 1000× magnification, of the microstructure of a layer 200, obtained by spraying pure copper with 1.5% of MW-CNTs, comprising a copper matrix 201 and CNTs 202 distributed discontinuously therein. Furthermore, so-called oxide skins 203 which are formed in the coating 200 by not entirely avoidable oxidation of the Cu powder during the mixing operation with the MW-CNTs can be seen on the Cu grains. The layers were sprayed at a nozzle outlet temperature of 600° C. and a pressure of 38 bar under N₂ gas. The density of the layer is 99.5%, the thickness thereof is 280 μm and the layer hardness is 1200 N/mm². On account of the good friction behavior, this layer is suitable as a running surface of bearings and bushes. The detachment of the 280 μm thick layer from the carrier material left a strip which can be used as a conductor track in leadframes or electromechanical structural elements.

With 300× magnification, FIG. 2B shows the surface of a layer 210, obtained by spraying pure Sn with 2.1% of MW-CNTs, comprising a tin matrix and CNTs distributed discontinuously therein. FIG. 2C shows a detailed view of FIG. 2B, with 10 000× magnification. The layer 210 comprises spherical Sn bodies 213 with CNTs 202 distributed therebetween. The density of the layer is 99.4%. It has a hardness of 368 N/mm² and, in the wear test, a coefficient of friction of 0.5. A layer thickness of 5 μm was obtained by spraying this layer under N₂ gas at a pressure of 32 bar and a nozzle outlet temperature of 350° C. By varying the nozzle outlet temperature, the movement velocity and the pressure, it is possible to significantly change (reduce) the layer thickness, the layer hardness and, in combination with the CNT content of the powder, the coefficient of friction. By aftertreatment such as leveling or remelting (reflow treatment), the surface structure of layers produced in this way can also be optimized in a targeted manner for the respective application. Applied to Cu alloy strips in part or over the entire area, these layers can serve to reduce plug-in forces and pulling forces in the case of electromechanical structural elements such as plug-in connectors, or after appropriate leveling and reflow steps can serve to improve the wear behavior in the case of plain bearings and bushes.

1. A process for producing a metal matrix composite material (200, 210) for electrical structural elements, electrical components or heat sinks, comprising a metal matrix (201, 211), which has at least one metal component, and at least one reinforcing component (202) arranged in the metal matrix (201, 211), characterized in that at least one of the components is sprayed onto a substrate (5) by a thermal spraying process, and in that the at least one reinforcing component used is carbon in the form of nanotubes (202), nanofibers, graphenes, fullerenes, flakes or diamond.

2. The process as claimed in claim 1, characterized in that the spraying process used is cold spraying, flame spraying and/or plasma spraying.

3. The process as claimed in claim 1, characterized in that the substrate (5) used is a film or a substrate with a non-wettable surface or a workpiece to be coated, a semi-finished product and/or a 3D structure.

4. The process as claimed in claim 1, characterized in that at least one surface of the substrate (5) and/or of the metal matrix composite material (200, 210) is machined.

5. The process as claimed in claim 1, characterized in that at least one metal component and/or at least one reinforcing component (202) is provided in particle form.

6. The process as claimed in claim 1, characterized in that a first component is mixed with at least one further component before spraying.

7. The process as claimed in claim 1, characterized in that at least one organic and/or at least one ceramic reinforcing component (202) is used.

8. The process as claimed in claim 1, characterized in that use is made of at least one further reinforcing component, which is selected from the group consisting of tungsten, tungsten carbide, tungsten carbide-cobalt, cobalt, copper oxide, silver oxide, titanium nitride, chromium, nickel, boron, boron carbide, Invar, Kovar, niobium, molybdenum, aluminum oxide, silicon nitride, silicon carbide, silicon oxide, zirconium tungstate and zirconium oxide.

9. The process as claimed in claim 1, characterized in that use is made of a metal matrix component having at least one metal and/or an alloy of a metal which is selected from the group consisting of tin, copper, silver, gold, nickel, zinc, platinum, palladium, iron, titanium and aluminum.

10. A metal matrix composite material (200, 210) comprising a metal matrix (201, 211), which has at least one metal component, and at least one reinforcing component (202) arranged in the metal matrix (201, 211), wherein the metal matrix composite material (200, 210) is produced by a process as claimed in claim 1.

11. The metal matrix composite material (200, 210) in particular as claimed in claim 10, which has a proportion of 0.1 to 20%, preferably 0.1 to 5%, preferably 0.2 to 5% of carbon nanotubes (202) as the reinforcing component.

12. The metal matrix composite material (200, 210) as claimed in claim 10, which has a residual porosity of 0.2 to 20% in relation to the reinforcing component and/or of 0.2 to 10% in relation to the metal component.

13. The use of a metal matrix composite material as claimed in claim 10 for producing a workpiece, wherein the workpiece is coated by the metal matrix composite material and/or formed from the metal matrix composite material.
